(19) United States
(12) Patent Application Publication
(10) Pub. No.: US 2014/0139396 A1
(43) Pub. Date: May 22, 2014

(54) ANTENNA AND ELECTRONIC DEVICE WITH ANTENNA

(71) Applicant: HON HAI PRECISION INDUSTRY CO., LTD., New Taipei (TW)

(72) Inventors: CHIH-MING HUNG, New Taipei (TW); HAN-PING MI, New Taipei (TW); LI-YAN TSAI, New Taipei (TW)

(21) Appl. No.: 13/787,815

(22) Filed: Mar. 7, 2013

(30) Foreign Application Priority Data
Nov. 19, 2012 (TW) 101143038

(51) Int. Cl. H01Q 9/04; H01Q 1/42

(52) U.S. Cl. CPC H01Q 9/04; H01Q 1/42
USPC 343/872; 343/700 MS

(57) ABSTRACT

An antenna includes a dielectric substrate, two pairs of antenna elements engaged on opposite sides of the dielectric substrate, two feed portions and a first connection element. Each antenna elements includes a first antenna electrode and a second antenna electrode connected to the first antenna electrode. A portion of the first antenna electrode is engaged on an upper surface of the dielectric substrate. A portion of the second antenna electrode is engaged on a lower surface of the dielectric substrate. Each of the two feed portions is connected between the ground and a conducive pad formed on the dielectric substrate. The first connection element is connected between the two antenna electrodes. A length of the first connection element is one-fourth wavelength of the first antenna electrode.

### BACKGROUND

1. Technical Field

The present disclosure relates to electronic devices and, particularly, to an electronic device with an antenna.

2. Description of Related Art

In general, antenna includes two pairs of antenna elements. Each pair of antenna elements includes a low-frequency element and a high-frequency element. When working, a current interference is generated between the two low-frequency elements or a high-frequency element, resulting in a low specification antenna.

Therefore, what is need is an antenna to avoid generating the current interference to overcome the described limitations.

### BRIEF DESCRIPTION OF THE DRAWINGS

FIG. 1 is an isometric view of an antenna in accordance with an exemplary embodiment.

FIG. 2 is an exploded view of the antenna of FIG. 1.

FIG. 3 is an exploded view of the antenna of FIG. 1, viewed from another aspect.

FIG. 4 is a block diagram of the hardware infrastructure of an electronic device with the antenna of FIG. 1, in accordance with an exemplary embodiment.

FIG. 5 shows a picture of a simulation effect of the antenna of FIG. 1.

### DETAILED DESCRIPTION

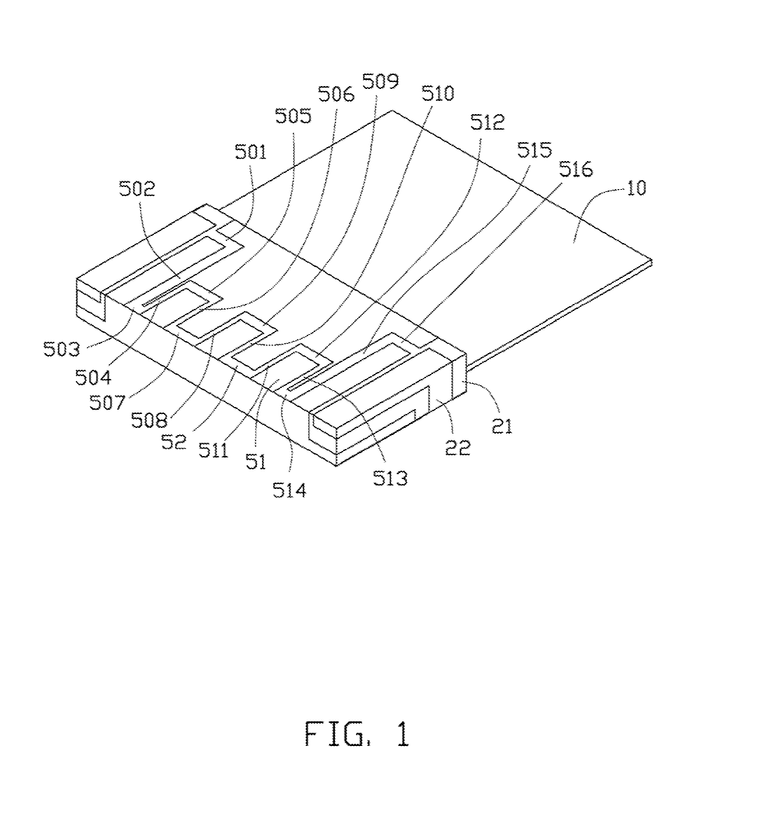

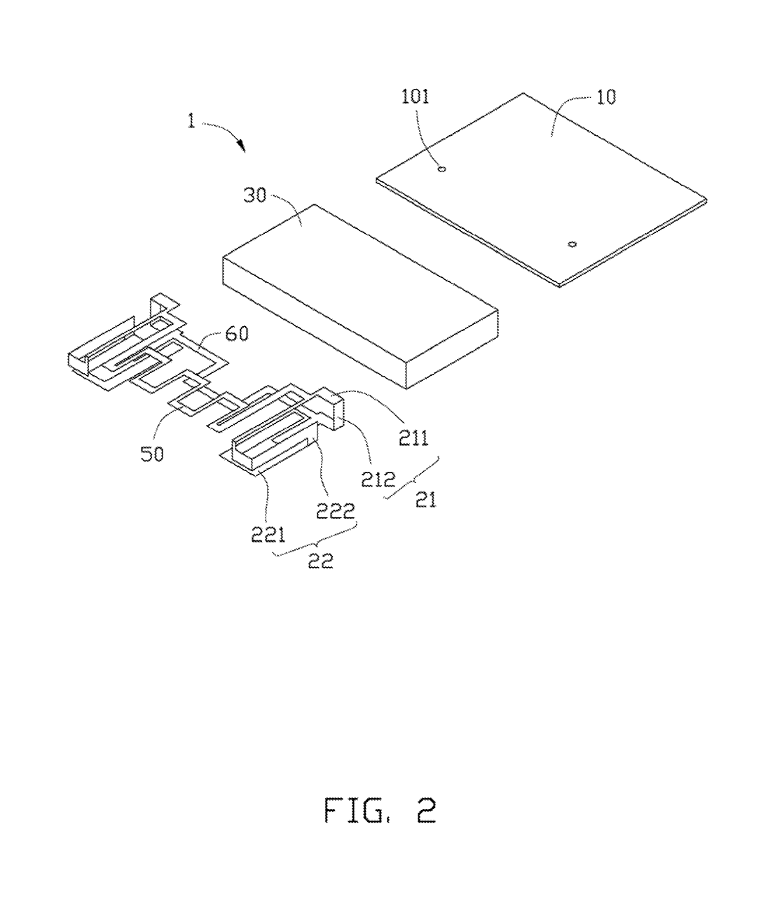

Referring to FIGS. 1-3, an antenna 1 is provided. The antenna 1 includes a dielectric substrate 10, two pairs of antenna elements 20 respectively engaged on opposite sides of the dielectric substrate 10, two feed portions 40, and a first connection element 50. A lower surface of the dielectric substrate 10 is connected to the ground. A conductive pad 101 is formed on the dielectric substrate 10.

Each pair of antenna elements 20 includes a first antenna electrode 21 and a second antenna electrode 22 connected to the first antenna electrode 21. A portion of the first antenna electrode 21 is engaged on an upper surface of the dielectric substrate 10, and a portion of the second antenna electrode 22 is engaged on a lower surface of the dielectric substrate 10. One end of each feed portion 40 is connected to the first antenna electrode 21, and an opposite end of each feed portion 40 is connected to the conductive pad 101 of the dielectric substrate 10. The first connection element 50 is connected between the two first antenna electrodes 21. The length of the first connection element 50 is equal to one-fourth wavelength of the first antenna electrode 21. In one embodiment, the two first antenna electrodes 21 are low-frequency antenna electrodes 21. When the length of the first connection element 50 is equal to one-fourth wavelength of the first antenna electrode 21, an infinite impedance will be generated between the two first antenna electrodes 21 to prevent the current from interference, thereby reducing the isolation valve of the low-frequency to less than a specifications values −8 dB based on the antenna theory. In one embodiment, the first connection element 50 is an elongate strip extending along a zigzag path, and the length of the first connection element 50 is a total length of the strip traversed along the zigzag path. Referring to FIG. 1 again, the length of the first connection element 50 is a sum of the length of the element 501, 502, 503, 504, 505, 506, 507, 508, 509, 510, 52, 511, 512, 513, 514, 515, and 516. In other embodiments, the first connection element 50 may be other shapes, such as elliptical-shaped, and the length of the first connection element 50 is a circumference of the ellipse when the first connection element 50 is elliptical-shaped.

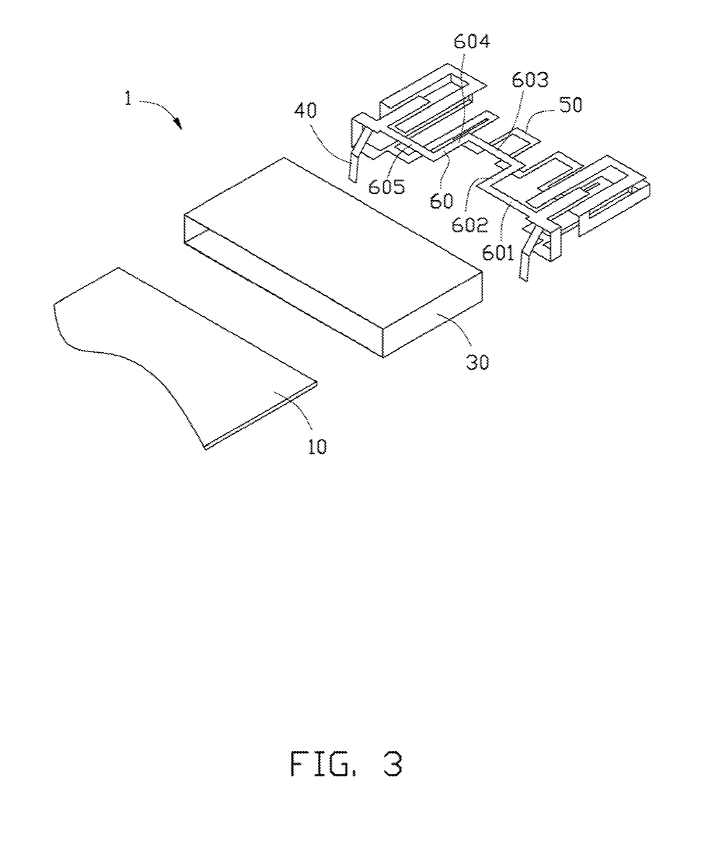

The antenna 1 further includes a second connection element 60 connected between the two second antenna electrodes 22. The length of the second connection element 60 is equal to one-fourth wavelength of the second antenna electrode 22. In one embodiment, the two second antenna electrodes 22 are high-frequency antenna electrodes 22. When the length of the second connection element 60 is equal to one-fourth wavelength of the second antenna electrode 22, an infinite impedance will be generated between the two second antenna electrodes 22 to prevent the current from interference, thereby reducing the isolation valve of the high-frequency to less than a specifications values −8 dB based on the antenna theory. In one embodiment, the second connection element 60 is an elongate strip extending along a zigzag path, and the length of the second connection element 60 is a total length of the strip traversed along the zigzag path. Referring to FIG. 3 again, the length of the second connection element 60 is a sum of the length of the element 601, 602, 603, 604 and 605. In other embodiments, the second connection element 60 may be other shapes, such as elliptical-shaped, and the length of the second connection element 60 is a circumference of the ellipse when the second connection element 60 is elliptical-shaped.

The antenna 1 further includes a housing 30 placed over the two pairs of antenna elements 20.

The first antenna electrode 21 includes a first forward part 211 engaged on the upper surface of the dielectric substrate 10 and a first backward part 212 engaged on the lateral surface of the dielectric substrate 10. In one embodiment, the first forward part 211 is L-shaped.

The second antenna electrode 22 includes a second forward 221 engaged on the lower surface of the dielectric substrate 10 and a second backward part 222 engaged the lateral surface of the dielectric substrate 10. In one embodiment, the second forward part 221 is U-shaped.

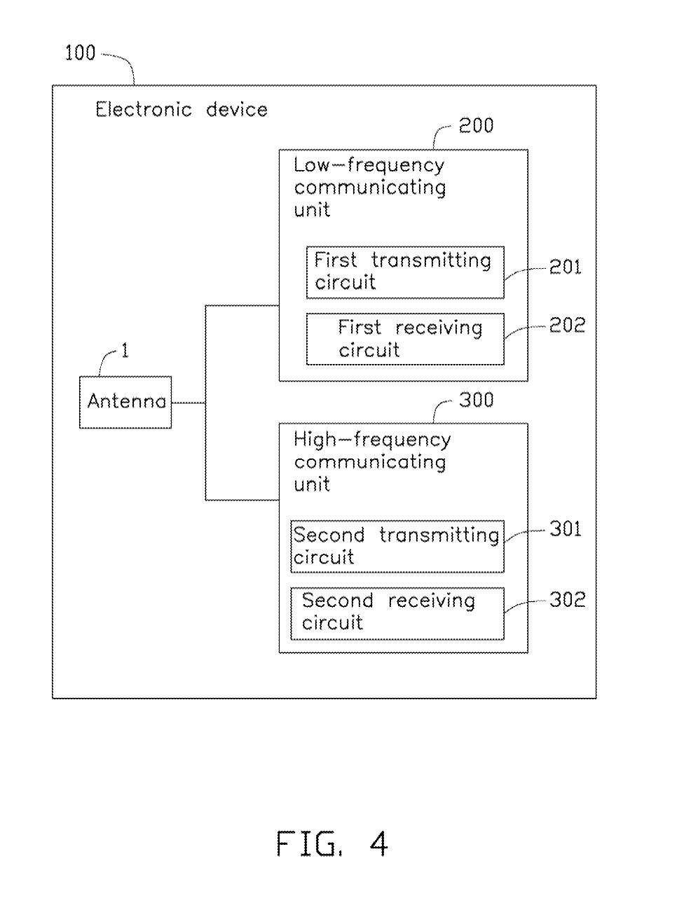

FIG. 4 is a block diagram of the hardware infrastructure of an electronic device with the antenna of FIG. 1, in accordance with an exemplary embodiment. The electronic device 100 includes a low-frequency communicating unit 200, a high-frequency communicating unit 300, and the antenna 1. The antenna 1 communicates with the low-frequency communicating unit 200 and low-frequency communicating unit 200.

The low-frequency communicating unit 200 includes a first transmitting circuit 201 and a first receiving circuit 202. The high-frequency communicating unit 300 includes a second transmitting circuit 301 and a second receiving circuit 302. The first transmitting circuit 201 transmits the low-frequency signal. The first receiving circuit 202 receives the low-frequency signal. The second transmitting circuit 301 transmits the high-frequency signal. The second receiving circuit 302 receives the high-frequency signal.

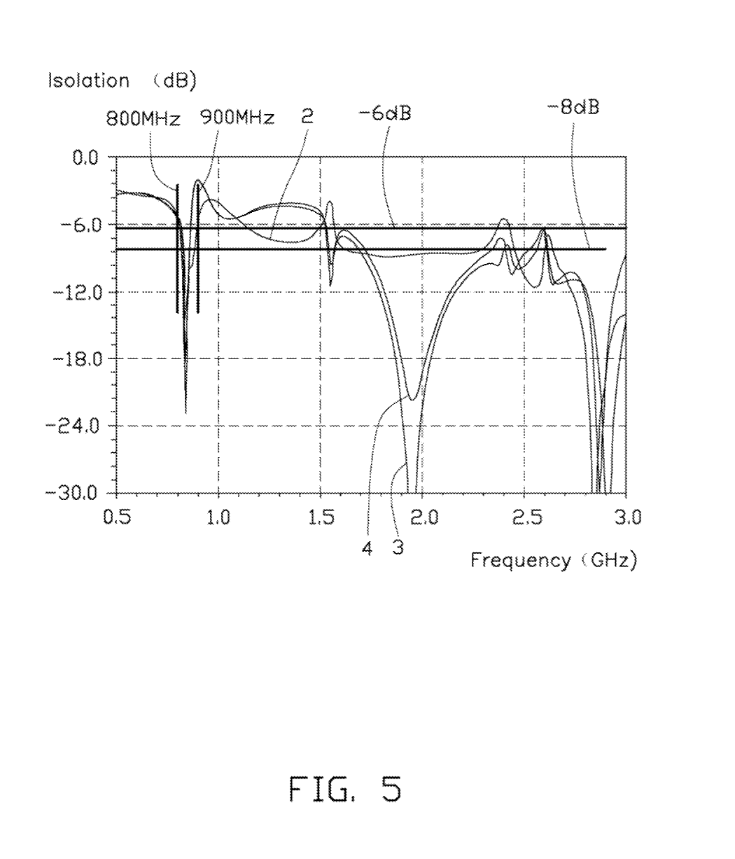

FIG. 5 shows that the isolation valve associated with an isolation line 2 is less than −8 dB. The return loss associated with a first converting line 3 of the first antenna electrode 21 is less than −6 dB. The return loss associated with a second converting line 4 of the second antenna electrode 22 is less than −6 dB when the frequency of the antenna is between 800 MHz-900 MHz.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An antenna comprising:
a dielectric substrate having a conductive pad formed thereon;
two pairs of antenna elements engaged on opposite sides of the dielectric substrate; wherein each pair of the antenna elements comprises a first antenna electrode and a second antenna electrode connected to the first antenna electrode, a portion of the first antenna electrode is engaged on an upper surface of the dielectric substrate, and a portion of the second antenna electrode is engaged on a lower surface of the dielectric substrate;
two feed portions, wherein each of the two feed portions is connected between the ground and the conducive pad of the dielectric substrate; and
a first connection element connected between the two first antenna electrodes, wherein a length of the first connection element is equal to one-fourth wavelength of the first antenna electrode.

2. The antenna as described in claim 1, further comprising:
a second connection element connected between the two second antenna electrodes, wherein a length of the second connection element is equal to one-fourth wavelength of the second antenna electrode.

3. The antenna as described in claim 1, wherein the first antenna electrode comprises a first forward portion engaged on the upper surface of the dielectric substrate and a first backward portion engaged on a lateral surface of the dielectric substrate.

4. The antenna as described in claim 1, wherein the second antenna electrode comprises a second forward portion engaged on the lower surface of the dielectric substrate and a second backward portion engaged on the lateral surface of the dielectric substrate.

5. The antenna as described in claim 3, wherein the first forward portion is L-shaped.

6. The antenna as described in claim 4, wherein the second forward portion is U-shaped.

7. The antenna as described in claim 1, further comprising:
a housing placed over the pairs of antenna elements.

8. The antenna as described in claim 1, wherein the first connection element is an elongate strip extending along a zigzag path, and the length of the first connection element is a total length of the strip traversed along the zigzag path.

9. The antenna as described in claim 2, wherein the second connection element is an elongate strip extending along a zigzag path, and the length of the second connection element is a total length of the strip traversed along the zigzag path.

10. An electronic device comprising:
a low-frequency communicating unit;
a high-frequency communicating unit; and
an antenna as described in claim 1, wherein the antenna is configured to communicate with the low-frequency communicating unit and the high-frequency communicating unit.
